(19) United States
(12) Patent Application Publication
(10) Pub. No.: US 2005/0223620 A1
(43) Pub. Date: Oct. 13, 2005

(54) Rattle for attracting fish

(76) Inventor: Dennis N. Pixton, Coconut Creek, FL (US)

Correspondence Address: Richard M. Saccocio;Richard M. Saccocio, P.A., 100 Southeast 12th Street, Ft. Lauderdale, FL, 33316, US

(21) Appl. No.: 11/105,247

(22) Filed: Apr. 13, 2005

Related U.S. Application Data
(60) Provisional application No. 60/561,494, filed on Apr. 13, 2004.

(51) Int. Cl. A01K 85/01

(52) U.S. Cl. 43/42.31

(57) ABSTRACT

A rattle for attracting fish, in one embodiment, includes a hollow cylindrical chamber that is sealingly closed by end caps. An annular, ring like member is positioned within the closed chamber so as to rest on its edge on the inner diameter of the closed chamber. The chamber diameter is larger than the outer diameter of the annular member thereby allowing the annular member to pivot on its edge when the rattle is rocked back and forth along its axial axis. The pivoting causes the annular member to strike the sides of the closed chamber thereby producing a type of clicking sound that is known to attract fish

### CROSS REFERENCE TO RELATED APPLICATIONS

This application is related to U.S. Provisional Application Ser. No. 60/561,494, filed on Apr. 13, 2004.

### BACKGROUND OF THE INVENTION

1. Field of the Invention

This invention relates in general to the field of fishing rattles and in particular to rattle to attract fish which rattle can be used alone or in combination with a fishing lure.

2. Description of the Prior Art

Fishermen using a pole and fishing line have for many years sought ways to better their chances of catching fish. It is known that fish have a lateral line on their body that responds to sound. Accordingly, devices have been advanced in the prior art to use the sound responding lateral line to attract fish and help catch them. These prior art devices have involved myriad technologies including electronic generation of various sounds and simple beads within a tube that emit a clicking noise when shaken. The general consensus in the fishing sport and industry is that the use of sound does indeed attract fish. The prior art sound producing devices are used with hard fishing lures such as crank baits, spoons, etc. and soft fishing lure such as plastic worms, crawdads, frogs, and other artificial baits that fish are known to eat.

One prior art rattle is used with a bullet shaped weight attached to a soft plastic artificial lure as seen in U.S. Pat. No. 5,381,622. In this prior art device, a sleeve is incorporated within the body of the bullet weight. The forward and aft ends of the sleeve is provided with a cap. A cylindrical weight that is configured to slide on the sleeve. When the cylindrical member hits either the forward or aft cap, a clicking sound is generated that can be heard outside of the bullet weight. This particular rattle however requires a generous amount of movement of the weight in order to have the cylindrical member slide on the sleeve the distance needed to strike the end caps. There are disadvantages to the generous movement required to generate the clicking sound. The generous movement must for example, be intentionally caused and usually does not occur when a slight twitching of the rod occurs or when the weight's movement slightly deviates from being pulled in a straight line or when the weight encounters a rock or a weed that causes the weight to deviate from a straight line movement.

Accordingly what is needed is a rattle that emits a clicking sound when an artificial lure, either hard or soft, is slightly moved be it intentionally or during the normal action of the lure as it is pulled through the water or encounters a natural object in the water.

The present invention is directed to such improved an improved rattle.

### SUMMARY OF THE INVENTION

The above-stated objects as well as other objects which, although not specifically stated, but are intended to be included within the scope the present invention, are accomplished by the present invention and will become apparent from the hereinafter set forth in this specification, the claims and the drawings presented herein.

The present invention, in one embodiment comprises a unique rattle that is attachable to a fishing weight, which is sometimes called a sinker, or that is used with a fishing weight, or that is used with an artificial soft or hard fishing lure. Yet another embodiment includes the unique rattle used with a fishing weight that includes a helical coil member and a sleeve, both of which extend from a back end of the fishing weight. The unique rattle includes a hollow cylindrical member capped on both ends with an annular member located within the hollow cylindrical member. A slight movement of the rattle causes the annular member to pivot within the hollow cylindrical member and strike either of the cap ends, thereby emitting one or more clicking sounds. In another embodiment, a small diameter sleeve extends axially within the center of the hollow cylindrical member. In this embodiment, the annular member includes an internal diameter that is sufficiently large such that the sleeve does not interfere with the pivoting action within the hollow cylindrical member.

In accordance with the above, there has been summarized the more important features of the present invention in order that the detailed description of the invention as it appears in the below detailed description of the same, may be better understood.

### BRIEF DESCRIPTION OF THE DRAWINGS

Various other objects, advantages, and features of the invention will become apparent to those skilled in the art from the following discussion taken in conjunction with the following drawing, in which:

FIG. 1 illustrates, in cross section, a simple embodiment of the inventive rattle;

FIG. illustrates a cross section of FIG. 1 taken through the line 2-2 thereof;

FIG. 3 illustrates, in cross section, a two chamber rattle of the embodiment of FIG. 1;

FIG. 4 illustrates, in cross section, the embodiment of FIG. 1 including a sleeve axially positioned within the body of the rattle;

FIG. 5 illustrates the embodiment of FIG. 4 adapted to a prior art bullet weight;

FIG. 6 illustrates the embodiment of FIG. 4 used with a screw on bullet weight; and

FIG. 7 illustrates the embodiment of FIG. 1 used with an artificial hard lure.

### DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functioning details disclosed herein are not to be interpreted as limiting, but merely as a basis for the claims and as a representative basis for teaching one skilled in the art to variously employ the present invention in virtually any appropriately detailed structure. Additionally, the verbiage used herein is intended to better enable a person to understand the invention and therefore, such verbiage is not to be interpreted as limiting the invention.

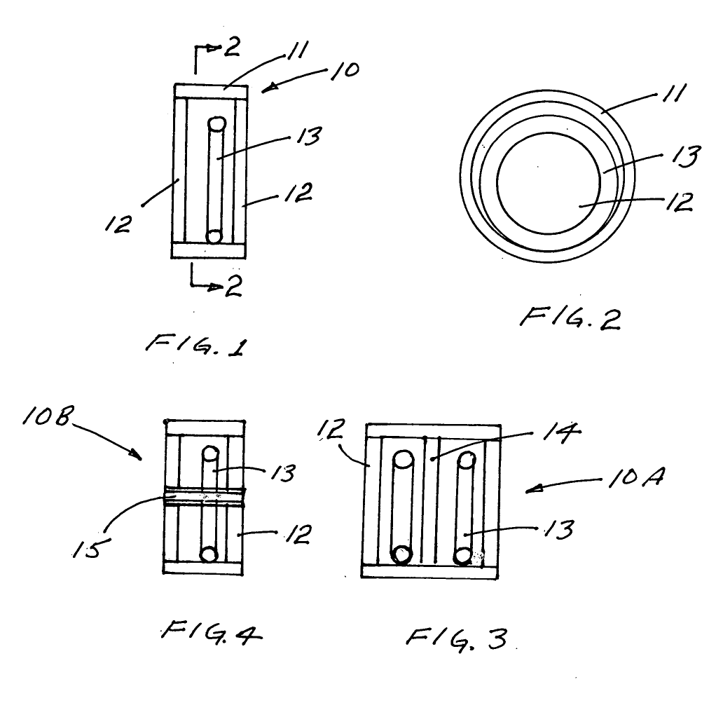

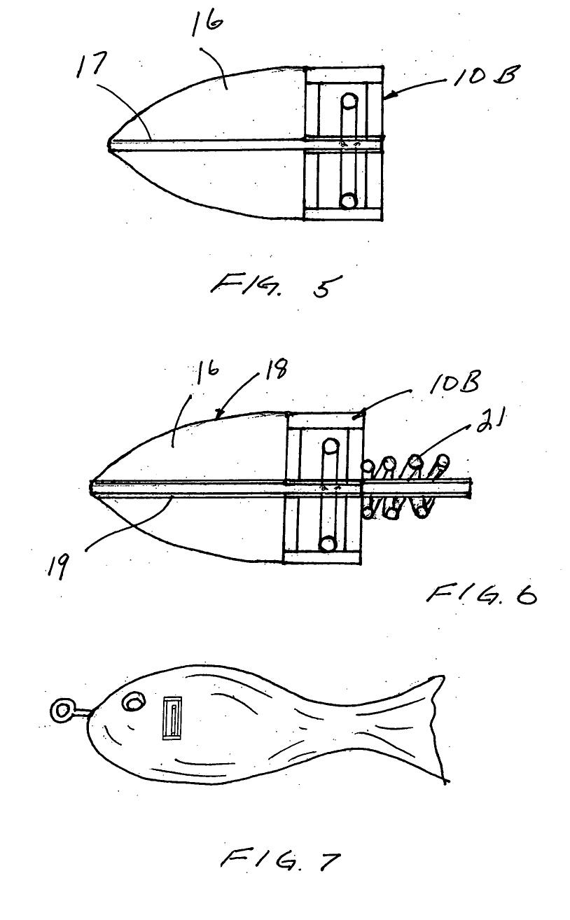

The details of the rattle 10 are shown in FIGS. 1 and 2. In this embodiment an annular body member 11 which comprises a hollow, substantially cylindrical member, or its equivalent, is fitted with end caps 12. An annular or ring like member 13 is located within the hollow cylindrical body 11. Annular member 13 is sized to have an outer diameter somewhat smaller that the internal diameter of the body 11 and such that when the annular member 13 rests vertically at one point against the internal diameter of body 11. In this manner, the annular member 13 is allowed to pivot at the point it rests against the internal diameter of body 11 without interfering with the internal diameter of body 11. The length of body 11 is sized such that a slight inclination of the rattle from the position shown in FIG. 1, allows the annular member 13 to pivot and strike one of the end caps 12. In practice, the internal length of body 11, between the end caps 12, can approximately be between the range of two or more times the thickness of annular member 13 but not more than the external or outer diameter of the annular member 13. In prototype testing a length of the internal length of body 11 of approximately three to four times the thickness of annular member has been shown to be satisfactory. The outer diameter of body 11 is not necessarily of any particular size; however, practical considerations of the way the rattle 10 is used either alone or in conjunction with other fishing lure apparatus, bears on the size of the outer diameter of the body 11 as it is used in practice. For example, if the inventive rattle 10 is used with a prior art bullet weight (see FIGS. 5 and 6) the outer diameter of the rattle 10 or the body 11 is preferably approximately equal to the outer diameter of the bullet weight. If the rattle 10 is to be used in conjunction with an artificial hard lure such as a crank bait, the outer diameter of body 11 and the overall size of the rattle 10 is dictated by the size of the crank bait, (see FIG. 7). The thickness of the wall of the body is also not a factor critical to the invention or its operation; but again, practical considerations will bear on the thickness. For example, the ability to sealingly connect the side caps 12 to body 11 is a practical factor. Body 11 can be configured to integrally include one end cap 12 with the other end cap 12 being sealingly secured to body 11. Or, both end caps 12 can be sealingly secured to a hollow cylindrical configuration of body 12. The size and configuration of the body and the end caps 12 as the rattle is used in practice, is within the knowledge of a person ordinarily skilled in the art of the invention.

Annular or ring-like member 13 can have a thickness of approximately one tenth of its outer diameter. A greater or lesser thickness can also be used; the main criteria being its ability to readily pivot within the body 11 when resting on a lower oriented point of the inner diameter of the body 11 and striking one of the end caps 12. Annular member 13 can have a circular cross sectional shape as seen in FIG. 1 or can have a square or rectangular cross sectional shape. A round cross sectional shape is preferred because of the ability of the round edges to readily pivot. However, an annular member 13 having a square or rectangular cross sectional shape, such as that of an ordinary flat washer can be used, but its performance will be enhanced if the outer diameter edges are rounded. The size and configuration of the annular member 13, as it is used in practice, is within the knowledge of a person ordinarily skilled in the art of the invention.

In order to aid in the tilting or pivoting movement of the ring-like member 13, it is preferable, but not necessary that the planer cross sectional configuration of the ring-like member 13 be substantially circular. However, an annular member having a plurality of flats or any such equivalent configuration along its outer diameter will also result in the pivoting action and clicking noises.

In use and operation of the inventive rattle 10, a slight inclination of the rattle from the position shown in FIG. 1 will cause the annular member 13 to pivot within the body 11 and strike one of the end caps 12 thereby producing a clicking sound. Such inclination can result from the rattle 10 being intentionally or non intentionally moved. For example if the rattle 10 is attached to an end of a fishing line that is attached to a fishing pole, a slight twitching of the fishing pole will result in intentional up and down inclination of the rattle 10 and result in a plurality of clicking noises by the annular member pivoting back and forth striking the end caps 12 each time the pivoting occurs. Or, if the line is being retrieved and the rattle 10 encounters a weed or a rock or other natural object, an unintentional up and down inclination of the rattle will occur and cause the clicking sounds. The above described construction of the inventive rattle 10 and its resulting sensitivity is thusly intended to advantageously use, both the intentional and unintentional movement of the rattle 10 to produce the clicking noises and thereby advantageously attract fish. Prototype testing has shown that due to the unique pivoting construction and operation of the rattle 10, very slight up and down inclinations will result in the producing of very audible clicking sounds of the type that has been demonstrated to attract fish.

The sensitivity of the inventive rattle 10 to produce fish attracting noises by slight movements of the rattle and the lure to which it can be attached is advantageous in murky waters as well as clear waters. While fishermen generally prefer to fish in clear water because of the belief that more fish are present in clear water, such belief is not necessarily true or at least some fish will be present in murky water. The sensitivity of the inventive rattle 10 will therefore allow fishermen to fish in murky waters as well as clear water and thereby broaden their scope of fishing and the ability to catch more fish, FIG. 3 illustrates, in cross section, a two chamber embodiment of FIG. 1. In this embodiment 10A, two annular members 13 are used within a body member 11 with a wall or plate member 14 positioned between the two annular members 13. The back and forth slight inclination of the rattle 10A thereby produces substantially twice the clicking sounds as compared to the embodiment of FIG. 1.

FIG. 4 illustrates, in cross section, the embodiment of FIG. 1 including a sleeve 15 axially positioned within the body 11 of the rattle 10B and through the end caps 12. Sleeve 15 allows a fishing line (not shown) to pass through the rattle 10B. Sleeve 15 is sealingly attached to end caps 12. In this embodiment 10B of the inventive rattle, the inner diameter of the annular member 13 is sized so as not to interfere with the sleeve 15 or be restricted by the sleeve 15 during the pivoting motion of the annular member 13. Such sizing knowledge is within that of a person of ordinary skill in the art of the invention.

FIG. 5 illustrates the embodiment 10B of FIG. 4 adapted to a prior art bullet weight 16. Typically, bullet weight 16 comprises a tapered weight member somewhat pointed at one end and flat or concave at an opposite end with a hole 17 through the axial centerline of the weight. Typically, the bullet weight 16 is placed at the front end of a soft artificial lure such as a worm to allow the lure to sink below the surface of the water in which the lure is used. The rattle 10B can be secured to the bullet weight in an appropriate manner as is known in the art, or can be simply placed between the weight 16 and the artificial lure. The sleeve 15 is aligned with the hole 17 in the weight member 16 so as to allow a fishing line to pas through both openings without snagging or binding. Accordingly, the opening though the sleeve 15 is preferably slightly larger than the hole 17 in the weight.

FIG. 6 illustrates the rattle embodiment 10B of FIG. 4 used a screw on bullet weight 18. In the prior art, a screw on bullet weight 18 serves the purpose of securely attaching a soft artificial lure to a weight member 16. A typical prior art screw on weight 18 includes a sleeve 19 extending through and out of the bullet weight 16. A helical member 21 is attached to the back of the weight 16 or to the sleeve 19. The helical member 21 permits the screw on weight 18 to be screwed into the front end of the artificial soft lure thereby securing the weight 16 to the artificial soft lure and rendering the lure to be considered weedless. In the embodiment of FIG. 6, the rattle 10B is placed between the back of the weight 16 and the front of the helical member 21.

FIG. 7 illustrates the rattle embodiment 10 of FIG. 1 used with an artificial hard lure 22. A typical prior art artificial hard lure 22 is made from a solid piece of balsa wood or plastic. Sometimes metal is used and the interior is hollow. In this embodiment, the rattle 10 is fitted to the body of the lure 22 and positioned substantially as shown or cross wise in the lure 22, depending on the type of lure 22 that is used. For example, some lures 22 will wiggle back and forth when retrieved. In this type of lure it would be advantageous to position the rattle 10 cross wise. Other lures 21 may move up and down when retrieved. In this type of lure it would be advantageous to position the rattle 10 as shown in FIG. 7.

The use of the inventive rattle in the embodiments shown in the drawings are not intended to be limiting. For example, where the embodiments show a single chambered rattle 10, the double chambered rattle of FIG. 3 can be used. Further, the sleeved rattle 10B can be configured to be a double or even a triple chambered rattle.

Simple trial and error testing by one having ordinary skill in the art can be used to determine appropriate materials to be used with the rattle 10 in order to achieve a desired sound and the loudness thereof. Both metal and plastic have been shown to work satisfactorily. Similar trial and error testing can be used to determine appropriate sizes and dimensions of the rattle components as explained above.

While the invention has been described, disclosed, illustrated and shown in certain terms or certain embodiments or modifications which it has assumed in practice, the scope of the invention is not intended to be nor should it be deemed to be limited thereby and such other modifications or embodiments as may be suggested by the teachings herein are particularly reserved especially as they fall within the breath and scope of the drawings and description provided herein.

1. Rattle apparatus that generates a noise that attracts fish comprising
a closed body member,
said closed body member comprising a hollow substantially cylindrical member having a first end and a second end,
said first and second ends being closed by side members,
an annular member contained within said closed body member,
said annular member having an outer diameter that is smaller than an inner diameter of said hollow substantially cylindrical member,
said annular member being free to pivot on said inner diameter of said hollow substantially cylindrical member when said outer diameter of said annular member rests on said inner diameter of said hollow substantially cylindrical member,
whereby pivoting of said annular member results in said annular member striking one of said side members causing said noise that attracts fish.

2. The rattle apparatus of claim 1 including a fishing lure, said rattle apparatus being located within said fishing lure.

3. The rattle apparatus of claim 1 including
a first tubular member axially centered within said body member and passing through said side members, and
said annular member having an inner diameter that is larger that an outer diameter of said tubular member.

4. The rattle apparatus of claim 3 including
a bullet weight,
said rattle apparatus being located at an end of said bullet weight

5. The rattle apparatus of claim 3 including
a screw on bullet weight,
said screw on bullet weight comprising a bullet weight, a second tubular member and a helical member, said second tubular member extending from an end of said bullet weight,
said rattle apparatus being located at said end of said bullet weight,
said helical member extending from an end of said rattle apparatus and around said second tubular member

6. Rattle apparatus that generates a noise that attracts fish comprising
a closed body member,
said closed body member comprising a hollow substantially cylindrical member having a first end and a second end,
said first and second ends being closed by side members,
said closed body member having two or more chambers contained therein,
each of said two or more chambers being separated by a partition therebetween,
two or more annular members
one of said two or more annular members being contained within each of said two or more chambers,
said annular members having an outer diameter that is smaller than an inner diameter of said hollow substantially cylindrical member,
said annular members each being free to pivot on said inner diameter of said hollow substantially cylindrical member when said outer diameter of said two or more annular members rest on said inner diameter of said hollow substantially cylindrical member,
whereby pivoting of said two or more annular members results in one of said annular members striking one of said side members and others of said two or more annular members striking said partition therebetween causing said noise that attracts fish.

7. The rattle apparatus of claim 6 including
a first tubular member axially centered within said body member and passing through said side members and said partition
said two or more annular member having an inner diameter that is larger that an outer diameter of said tubular member

8. The rattle apparatus of claim 6 including a fishing lure, said rattle apparatus being located within said fishing lure.

9. The rattle apparatus of claim 7 including
a bullet weight,
said rattle apparatus being located at an end of said bullet weight

10. The rattle apparatus of claim 7 including
a screw on bullet weight,
said screw on bullet weight comprising a bullet weight, a second tubular member and a helical member, said second tubular member extending from an end of said bullet weight,
said rattle apparatus being located at said end of said bullet weight,
said helical member extending from an end of said rattle apparatus and around said second tubular member

11. Rattle and weight apparatus that generates a noise that attracts fish
said rattle apparatus comprising
a closed body member,
said closed body member comprising a hollow substantially cylindrical member having a first end and a second end,
said first and second ends being closed by side members,
at least one annular member contained within said closed body member,
a tubular member axially centered within said body member and passing through said side members,
said at least one annular member having an outer diameter that is smaller than an inner diameter of said hollow substantially cylindrical member,
said at least one annular member being free to pivot on said inner diameter of said hollow substantially cylindrical member when said outer diameter of said annular member rests on said inner diameter of said hollow substantially cylindrical member,
whereby pivoting of said at least one annular member results in said at least one annular member striking one of said side members causing said noise that attracts fish,
said weight apparatus comprising a bullet weight,
said rattle apparatus being located at an end of said bullet weight.
